(19) United States
(12) Patent Application Publication
(10) Pub. No.: US 2008/0047660 A1
(43) Pub. Date: Feb. 28, 2008

(54) PEEL PLATE ASSEMBLY FOR REMOVING PROGRAMMABLE TRANSPONDERS FROM A WEB

(75) Inventors: Donald W. Angel, Cincinnati, OH (US); John T. Glenski, Cincinnati, OH (US)

Correspondence Address: Stephen B. Salai, Esq.;Harter, Secrest & Emery LLP, 1600 Bausch & Lomb Place, Rochester, NY, 14604-2711, US

(73) Assignee: WS PACKAGING GROUP, INC., Algoma, WI (US)

(21) Appl. No.: 11/463,107

(22) Filed: Aug. 8, 2006

(51) Int. Cl. B65C 9/18

(52) U.S. Cl. 156/238; 340/10.1; 340/572.1; 29/593; 702/82; 156/168

(57) ABSTRACT

A peel plate assembly for selectively removing RFID tags from a web for applying the RFID tags to a succession of articles includes an extendible or retractable peel blade and an RFID sensor recess mounted within a plate body. A cover for the plate body functions both as a web guide for advancing a succession of RFID tags past the sensor to the peel blade and as part of a shielding system to isolate communications between the sensor and the closest RFID tag to the peel blade.

### BACKGROUND OF THE INVENTION

1. Field of the Invention

The invention relates to the selective application of programmable transponders, such as radio frequency identification devices (RFIDs), to articles, such as product packaging, shipping containers, or products themselves. Peel plate assemblies together with peel blade actuators, and interrogating devices support the selective application of the programmable transponders.

2. Description of Related Art

Programmable transponders, particularly in the form of radio frequency identification devices (RFIDs), are widely used as identification and tracking devices capable of local communications without requiring line of sight access. Information can be written into the programmable transponders and read from the programmable transponders via local transmissions typically in the form of radio waves.

The programmable transponders can be embedded within pressure-sensitive label structures, sometimes referred to as RFID tags, which are arranged in succession along a continuous web. An applicator coordinates the transfer of the embedded label structures from the web to a succession of articles, such as cartons, boxes, or other product packaging or shipping containers. The applicators can be incorporated into inline machines for forming, filling, or stacking, the articles to minimize any additional handling of the articles.

The programmable transponders are preferably programmed to match the articles to which they are applied or pre-programmed and read before being associated with particular articles. Care must be taken to avoid reprogramming transponders that have already been programmed or reading preprogrammed transponders out of sequence. The programmable transponders are generally programmed or pre-programmed and read before the programmable transponders are applied to articles because article-to-article variations make subsequent communications less reliable. At high processing speeds, such less reliable communications can lead to an increased number of programmable transponders being mis-programmed or misread as defective. Defective transponders applied to articles can require scrapping packaging together with the defective transponders, which is more time consuming and expensive than detecting transponder defects earlier and with more reliability.

An interrogating device programs and reads or just reads the passing transponders. Any defective transponders detected along the web of transponders must be tracked until the transponders arrive at the point of application. There, only the successfully polled transponders are preferably applied to the articles. Asynchronous web operations are required to skip one or more defective transponders without interfering with the ongoing processing of the articles.

The interrogating devices generally include antenna located close to the web. However, many difficulties have been encountered including threading the webs past the antenna, damaging antenna that track too close to the web, encountering interference from nearby transponders, accidentally re-encoding or re-reading the nearby transponders, and limiting locations of the transponders on the webs.

### BRIEF SUMMARY OF THE INVENTION

The invention features a peel plate assembly of the type that can be incorporated into an applicator for selectively applying programmable transponders to articles. Preferably, the programmable transponders are embedded within label or tag structures that are arranged in a succession along a web. An interrogating device preferably includes an antenna that is protected inside a plate body of the peel plate assembly across which the web is guided. The antenna can be shielded behind a web guide of the peel plate assembly for limiting communications with the antenna to one transponder at a time. A peel blade of the peel plate assembly is moveable into and out of positions interrupting the web guide for selectively removing embedded transponders from the web. An actuator for the peel blade is responsive to the results of the interrogation so that only successfully polled transponders are removed from the web. Mounting the antenna within the peel plate and behind a web guide protects the antenna from damage, avoids complications with the threading of the web, and isolates communications between the antenna and individually embedded transponders.

One version of the invention as a peel plate assembly includes a peel plate supporting both a polling device and a peel blade. A web guide, which formed on a surface of the peel plate, guides a web across the peel plate through positions at which a succession of programmable transponders carried along the web are moved into and out of communication with the polling device. A controller monitors communications between the polling device and the programmable transponders for determining if the polled programmable transponders meet a pass/fail condition. An actuator moves the peel blade into or out of engagement with the web for selectively removing programmable transponders from the web in response to whether the programmable transponders meet the pass/fail condition.

The web guide is preferably arranged as a shield for isolating communications between the polling device and individual programmable transponders. The peel plate preferably includes a plate body having a recess, and the polling device is preferably supported within the recess of the plate body. The web guide can be arranged as a cover for the plate body, and the cover preferably includes an opening for supporting communications between the polling device and the individual programmable transponders. The plate body also preferably functions as a shield surrounding the polling device for isolating communications between the polling device and individual programmable transponders that are aligned with the opening in the cover.

The actuator relatively moves the peel blade with respect to the web guide for moving the peel blade into and out of engagement with the web. The peel blade can be positioned in engagement with the web for removing programmable transponders that successfully meet the pass/fail condition for applying the successful programmable transponders to another article. The peel blade can also be positioned out of engagement with the web for allowing programmable transponders that do not successfully meet the pass/fail condition to remain on the web. Preferably, the polling device is arranged in relation to the peel blade so that the polling device polls the programmable transponder closest to reaching the peel blade.

Another version of the invention as an applicator for applying programmable transponders to articles includes (a) a web transport for advancing a web containing a succession of programmable transponders and (b) an article transport for advancing a succession of articles in coordination with the advancing web. A peel plate has a web guide and a moveable peel blade for selectively removing programmable transponders from the web for application to the articles. An interrogating device has an antenna mounted in the peel plate adjacent to the web guide for polling the programmable transponders as the programmable transponders are advanced across the peel plate. An actuator moves the peel blade into or out of engagement with the web for applying successfully polled programmable transponders to the articles or allowing unsuccessfully polled articles to remain with the web.

The web guide also preferably provides a shield that isolates the programmable transponder closest to reaching the peel blade for polling and excludes from polling other programmable transponders that are more remote from the peel blade. The web guide can be formed as a cover for the peel plate having an opening aligned with the antenna. Preferably, the peel plate includes a body having a cavity for receiving the antenna and for shielding the antenna from polling the other programmable transponders that are more remote from the peel blade.

The peel plate can also function as a shield for further isolating communications between the antenna and programmable transponder closest to the peel blade. The web guide preferably includes an arcuate portion for advancing the web together with the programmable transponders beyond the peel plate for transporting unsuccessfully polled programmable transponders toward a web take-up station.

The actuator preferably moves the peel blade into and out of a position that interrupts the arcuate portion of the web guide for peeling the programmable transponders from the web. In addition, the actuator is preferably mounted on the peel plate, and linearly translates the peel blade into and out of engagement with the web.

Both a planer face of the peel plate and an arcuate sidewall of the peel plate preferably contribute to forming the web guide. The antenna can be operatively exposed through an opening in the planer face, and the peel blade can be moved into a position that displaces the web from at least a portion of the arcuate sidewall of the peel plate. The programmable transponders can take the form of radio frequency identification devices that are mounted in pressure-sensitive labels and arranged on a release surface of the web.

### BRIEF DESCRIPTION OF THE SEVERAL VIEWS OF THE DRAWINGS

FIG. 1 is a plan view of a peel plate assembly in accordance with the invention.

FIG. 2 is an end view of the peel plate assembly showing a web guide of the assembly in profile.

FIG. 3 is a perspective view of the peel plate assembly.

FIG. 4 is an enlarged cutaway view of the peel plate assembly with its peel blade extended for peeling RFID tags from a web.

FIG. 5 is a similarly enlarged cutaway view of the peel plate assembly with its peel blade retracted to allow the RFID tags to remain on the web.

FIG. 6 is a diagram of an applicator incorporating the peel plate assembly for selectively applying RFID tags to articles.

### DETAILED DESCRIPTION OF THE INVENTION

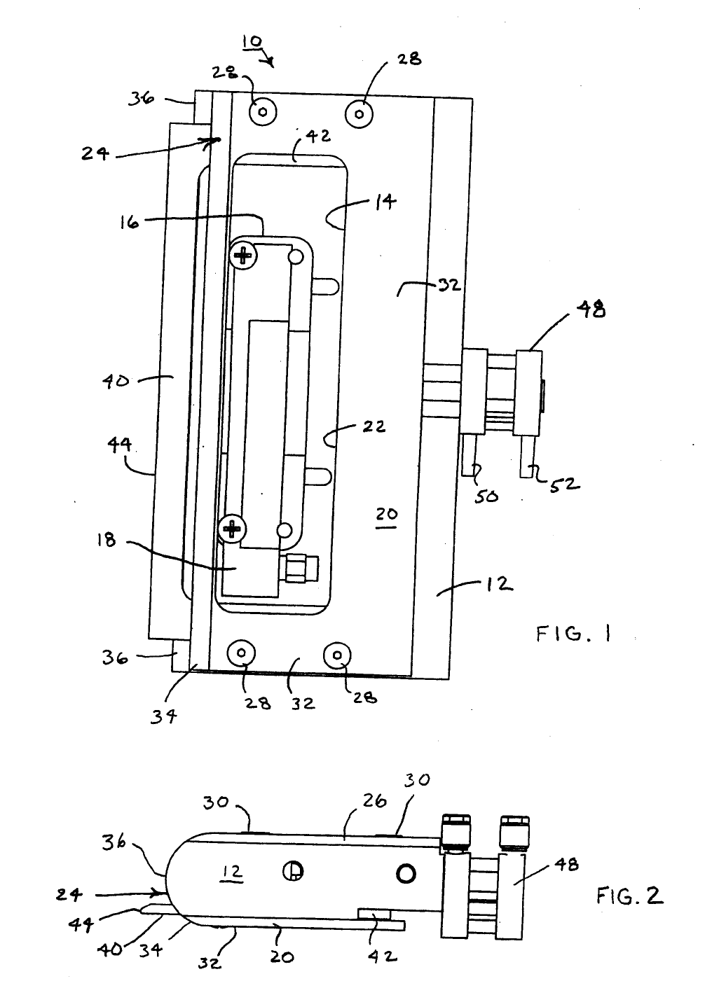

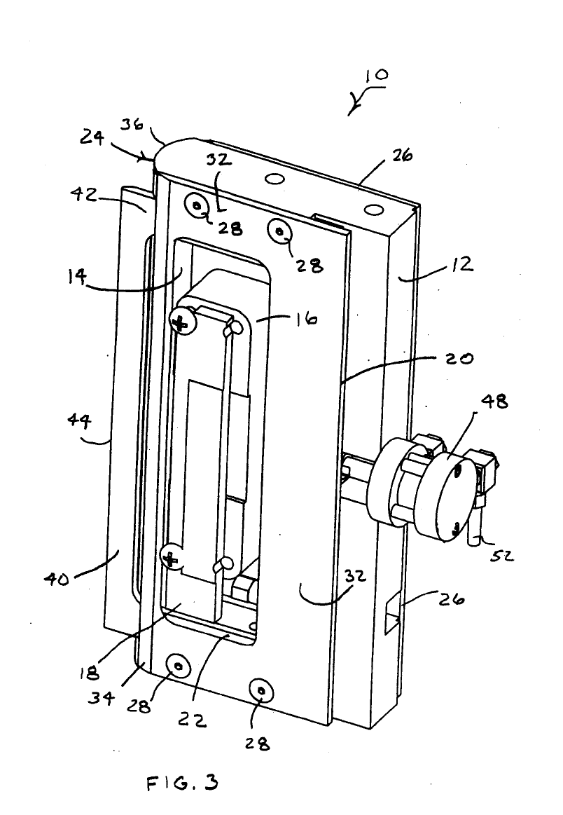

A peel plate assembly 10 as shown in FIGS. 1-3 is arranged as a preferred embodiment of the invention. The peel plate assembly 10 has a plate body 12 with a through opening in the form of a pocket 14 for receiving a RFID sensor 16 including an antenna 18. A front cover 20, which includes an opening 22 for exposing the antenna 18 within the pocket 14, functions both as a portion of a web guide 24 for directing an RFID tag web (not shown) across the peel plate assembly 10 and as a shield for restricting radio communications with the antenna 18. A back cover 26 mounts the RFID sensor 16 within the pocket 14.

Both the front cover 20 and the back cover 26 are affixed to the plate body 12 by recessed screws 28 and 30. However, the covers could be affixed in a variety of other ways, or one or both of the front and back covers 20 and 26 could be formed as an uninterrupted integral part of the plate body 12. At least the front cover 20 is preferably made of stainless steel for purposes of shielding radio frequency communications and providing a non-reactive web guide 24. However, the back cover 26 and the plate body 12 are also preferably made of electrically shielding metals, such as stainless steel, or metal composites to further restrict radio communications with the antenna 18. As such, the radio communications are preferably limited to the space within the opening 22 of the front cover 20 over which the RFID tag web (not shown) is directed.

The web guide 24 is formed by a substantially planar face 32 of the front cover 20 together with an arcuate sidewall 34 of the plate body 12. The substantially planar face 32 is blended by a tapered portion 34 together with the arcuate sidewall 36 to provide a smooth guide way for advancing the RFID tag web (not shown) over the substantially planar face 32 of the front cover 20 (thereby exposing RFID tags carried by the web to RF communications with the recessed antenna 18) and around the arcuate sidewall 36 of the plate body 12 (for selectively removing the RFID tags from the web).

Also mounted within the peel plate assembly 10 is a retractable peel blade 40 having a planar blade body 42 that is slidably mounted between the plate body 12 and the front cover 20. In the position shown in FIGS. 1-3, an edge 44 of the peel blade 40 extends beyond the arcuate sidewall 36 of the plate body 12 interrupting the web guide 24 for peeling the RFID tags (not shown) from the web (also not shown). A linear actuator depicted as an air cylinder 48 translates the peel blade 40 between the extended position shown and a retracted position that does not interrupt the web guide 24. Airflow conduits 50 and 52 provide for reversing airflow directions to the air cylinder 48 for translating the peel blade 40 in opposite directions. A variety of other actuators could be used for this purpose including electromechanical or hydraulic actuators.

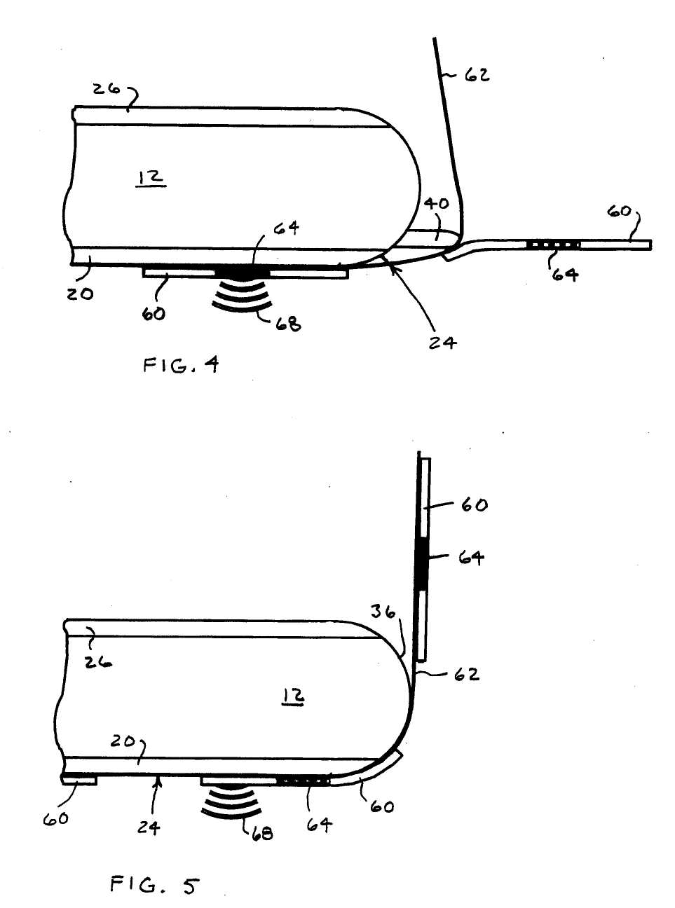

FIGS. 4 and 5 depict an example of the intended operation of the peel plate assembly 10 for selectively removing RFID tags 60 from and advancing web 62. Programmable RFID transponders 64 embedded within the RFID tags 60 are preferably capable of receiving RF energy for powering or activating the transformer so that information can be written into the transformer (i.e., programmed) or read from the transformer. The RFID tags 60 can be constructed in the form of pressure-sensitive labels or other laminated structures for mounting the programmable transponders 64 on articles including product packaging or shipping containers.

In FIG. 4, the peel blade 40 is extended for peeling one of the RFID tags 60 from the web 62 while another of the RFID tags 60 is within a read/write zone 68 of the RFID sensor 16 (shown in FIGS. 1 and 3). Shielding provided by the front cover 20, the back cover 26, and the plate body 12 limits the read/write communications to the transponder 64 of a single RFID tag 60 as the RFID tag 60 passes through the read/write zone 68.

In FIG. 5, the peel blade 40 is retracted for allowing the RFID tags 60 to remain on the web 62. The two full-length RFID tags 60 of FIG. 5 have already passed through the read/write zone 68 of the RFID sensor and have been determined to be defective or otherwise unsuitable for being removed from the web 62.

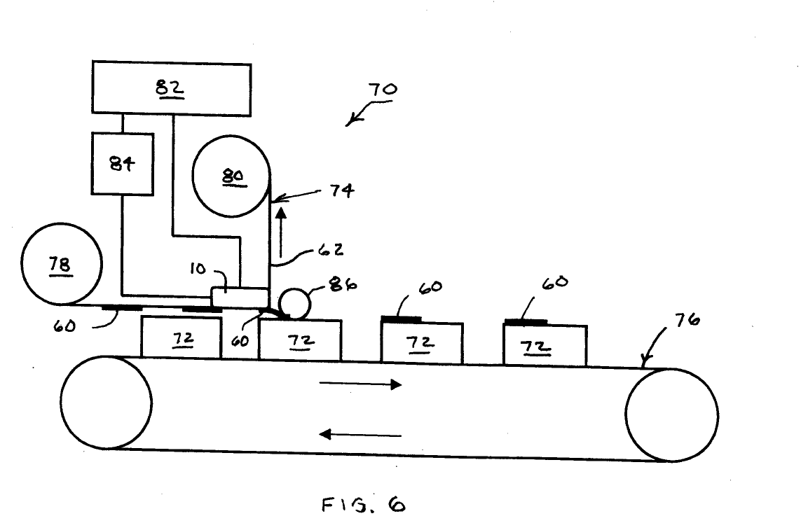

An applicator 70 for selectively applying the RFID tags 60 to articles 72 is depicted in FIG. 6. The articles 72 are shown as boxes, but the articles can take a variety of other forms including product packaging or shipping containers as well as the products themselves. The peel plate assembly 10 is positioned along a web transport 74 proximate to an article transport 76. The web transport 74 moves the web 62 along a pathway between an unwind reel 78 and a rewind reel 80 or other form of take up for the web 62. The article transport 76 moves the articles 72 past the peel plate assembly 10 for applying the RFID tags 60 stripped from the web 62 to a succession of articles 72.

A micro-controller 82 controls the RFID sensor 16 (shown in FIGS. 1 and 3) within the peel plate assembly 10 for polling the individual programmable transponders 64. The polling operation, which is also referred to as an interrogation, can include both writing to and reading from the programmable transponders 64 or just reading from the programmable transponders 64. The combination of shielding and close proximity of the programmable transponders 64 as they are guided across the peel plate assembly 10 assures that the polling can be conducted with high accuracy.

The RFID tags 60 with successfully polled transponders 64 are immediately removed from the web 62 by the extension of the peel blade 40. No special tracking of the polled RFID tags 60 is required because the RFID tags 60 are polled adjacent to the peel blade 40 and are next in line for removal from the web 62. Once an RFID tag 60 is successfully polled, e.g., meets a threshold condition as determined by the micro-controller 82, a signal is delivered to a blade actuator controller 84 for extending or allowing the peel blade 40 to be extended. A pneumatic actuator is preferably used for both extending and retracting the peel blade 40. However, hydraulic or electromechanical systems could also be used, including systems in which the peel blade 40 is biased by a potential energy source (e.g., a spring) into one or the other of its positions. A label or tag handler 86, which can also take a number of conventional forms, affixes the removed RFID tags 60 to the articles 72.

If, in contrast, an RFID tag 60 is unsuccessfully polled, e.g., does not meet a threshold condition such as exhibiting a weak signal or incorrect information, the micro-controller 82 sends a signal for retracting the peel blade 40. With the peel blade 40 retracted, the RFID tags 60 remain on the web 62 as the web 62 is guided around the arcuate sidewall 36 of the plate body 12 en route to the rewind reel 80 of the web transporter 74. Thus, RFID tags 60 with defective programmable transponders 64 remain on the web 62 instead of being applied to the articles 72. Preferably, the web transport 74 and the article transport 76 are capable of operating asynchronously so that one or more unsuccessfully polled RFID tags 60 can be skipped over while continuing to apply successfully polled RFID tags 60 to an uninterrupted sequence of the articles 72.

The preferred embodiment can be described as a “one-off application” because the RFID tag 60 closest to the peel blade 40 is interrogated just before applying the RFID tag 60 to an article 72. In fact, communications with the polled RFID tags 60 take place as the RFID tags 60 are guided across the peel plate assembly 10. The broadcast and receiving antenna 18 is mounted within a recess of the plate body 12 beneath a cover plate 20 that also functions as a portion of a web guide. The mounting accurately positions, protects, and shields the antenna 18 to safely isolate communications and improve readability between the antenna 18 and the programmable transponder 64 within the RFID tag 60 that is closest to the peel blade 40. Extended life and increased versatility of the applicator systems are also expected, including the ability to selectively apply different size tags or labels to articles.

1. A peel plate assembly comprising
a peel plate supporting both a polling device and a peel blade,
a web guide formed as a surface of the peel plate for guiding a web across the holder through positions at which a succession of programmable transponders carried along the web are moved into and out of communication with the polling device,
a controller that monitors communications between the polling device and the programmable transponders for determining if the polled programmable transponders meet a pass/fail condition, and
an actuator that moves the peel blade into or out of engagement with the web for selectively removing programmable transponders from the web in response to whether the programmable transponders meet the pass/fail condition.

2. The assembly of claim 1 in which the web guide is arranged as a shield for isolating communications between the polling device and individual programmable transponders.

3. The assembly of claim 2 in which peel plate includes a plate body having a recess, and the polling device is supported within the recess of the plate body.

4. The assembly of claim 3 in which the web guide is arranged as a cover for the plate body and the cover includes an opening for supporting communications between the polling device and the individual programmable transponders.

5. The assembly of claim 4 in which the plate body also functions as a shield surrounding the polling device for isolating the communications between the polling device and individual programmable transponders that are aligned with the opening in the cover.

6. The assembly of claim 1 in which the actuator relatively moves the peel blade with respect to the web guide for moving the peel blade into and out of engagement with the web.

7. The assembly of claim 6 in which the peel blade is positioned in engagement with the web for removing programmable transponders that successfully meet the pass/fail condition for applying the successful programmable transponders to another article.

8. The assembly of claim 7 in which the peel blade is positioned out of engagement with the web for allowing programmable transponders that do not successfully meet the pass/fail condition to remain on the web.

9. The assembly of claim 1 in which the polling device is arranged in relation to the peel blade so that the programmable transponder closest to reaching the peel blade is polled by the polling device.

10. An applicator for applying programmable transponders to articles comprising
a web transport for advancing a web containing a succession of programmable transponders,
an article transport for advancing a succession of articles in coordination with the advancing web,
a peel plate having a web guide and a moveable peel blade for selectively removing programmable transponders from the web for application to the articles,
an interrogating device including an antenna mounted in the peel plate adjacent to the web guide for polling the programmable transponders as the programmable transponders are advanced across the peel plate, and
an actuator for moving the peel blade into and out of engagement with the web for applying successfully polled programmable transponders to the articles and for allowing unsuccessfully polled articles to remain with the web.

11. The applicator of claim 10 in which the web guide also provides a shield that isolates the programmable transponder closest to reaching the peel blade for polling and excludes from polling other programmable transponders that are more remote from the peel blade.

12. The applicator of claim 11 in which the web guide is formed as a cover for the peel plate having an opening aligned with the antenna.

13. The applicator of claim 12 in which the peel plate includes a body having a cavity for receiving the antenna and for shielding the antenna from polling other programmable transponders that are more remote from the peel blade.

14. The applicator of claim 13 in which the peel plate also functions as a shield for further isolating communications between the antenna and programmable transponder closest to the peel blade.

15. The applicator of claim 10 in which the web guide includes an arcuate portion for advancing the web together with the programmable transponders beyond the peel plate for transporting unsuccessfully polled programmable transponders toward a web take-up station.

16. The applicator of claim 15 in which the actuator moves the peel blade into and out of a position that interrupts the arcuate portion of the web guide for peeling the programmable transponders from the web.

17. The applicator of claim 16 in which the actuator is mounted on the peel plate, and linearly translates the peel blade into and out of engagement with the web.

18. The applicator of claim 10 in which both a planer face of the peel plate and an arcuate sidewall of the peel plate contribute to forming the web guide.

19. The applicator of claim 18 in which the antenna is operatively exposed through an opening in the planer face and the peel blade is moveable into a position that displaces the web from at least a portion of the arcuate sidewall of the peel plate.

20. The applicator of claim 10 in which the programmable transponders take the form of radio frequency identification devices that are mounted in pressure-sensitive labels and arranged on a release surface of the web.
